(19) United States
(12) Patent Application Publication
(10) Pub. No.: US 2006/0204943 A1
(43) Pub. Date: Sep. 14, 2006

(54) VOIP e-learning system

(75) Inventor: Andrew Kimball, Fairfax, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: QBInternational, San Rafael, CA (US)

(21) Appl. No.: 11/371,345

(22) Filed: Mar. 7, 2006

Related U.S. Application Data
(60) Provisional application No. 60/660,562, filed on Mar. 10, 2005.

(51) Int. Cl. G09B 5/00; G09B 7/00

(52) U.S. Cl. 434/307 R; 434/362

(57) ABSTRACT

An e-learning system provides learning content and interactive learning games to users using computer systems and voice-over IP (VOIP) telephones and other devices. The e-learning system includes an authoring system allowing the creation of customized learning content and interactive learning games. A content presentation module presents learning content to users of computers and VOIP telephones and other devices. A data collection module receives user data from the VOIP device indicating the user's performance with the interactive games. In a further embodiment, a user data presentation module analyzes the user data and presents a report including user data. The interactive learning games are designed to reinforce and measure users' understanding of the instructional content provided by the content presentation module. In some applications, the learning content pertains to functions of the VOIP device and the interactive learning games simulate the functions of the VOIP device.

### CROSS-REFERENCE TO RELATED APPLICATIONS

This application claims priority to U.S. Provisional Patent Application No. 60/660,562, filed Mar. 10, 2005, the disclosure of which is incorporated by reference herein.

### BACKGROUND OF THE INVENTION

This invention is related to the field of electronic learning systems and software applications for the creation of the same. Organizations typically devote a large amount of time and resources to educate and train their members. As organizations face increasing training requirements and reduced training budgets, they are using educational software applications, referred to as e-learning applications, to meet their training needs.

Although e-learning applications allow organizations to train employees with minimal expense and supervision, the results of many e-learning applications are poor. Typical e-learning applications are designed to teach general topics and are not tailored to the specific needs of an organization. As a result, pre-packaged e-learning applications are often perceived by an organization's members as irrelevant, instructionally ineffective, and dull. E-learning applications can be customized to suit the needs of an organization and its members; however, producing customized e-learning applications is time consuming and expensive. Additionally, although interactive e-learning applications, such as those including instructional games and simulations, help retain users' interest and improve retention, customization of interactive elements is typically extremely expensive.

Additionally, many organizations would like to be able to deploy e-learning application in a consistent and organized manner. Furthermore, organizations would like to be able to monitor its members participation and performance in training activities. However, typical e-learning applications are difficult to deploy across organizations and offer limited, if any, reporting capabilities.

Moreover, many organizations are deploying voice-over Internet protocol (VOIP) telephones, other packet-switched voice and video communication systems, and other advanced communication infrastructure upgrades. Employee training is often essential for successful deployment of these technologies. Furthermore, many organizations, such as retail stores, may not have computers readily available to employees for training purposes.

It is therefore desirable for an e-learning system to provide organizations with an integrated system for rapidly and inexpensively creating customized, interactive e-learning applications tailored to the specific needs of organizations and its members. It is further desirable for an e-learning system to provide organizations with an integrated system for managing the deployment of e-learning applications and monitoring member participation and performance in these e-learning applications. It is further desirable for an e-learning system to be capable of creating and deploying effective e-learning applications on VOIP telephones and other packet-switched voice and video communication systems.

### SUMMARY OF THE INVENTION

An embodiment of the invention includes an e-learning system adapted to provide learning content and interactive learning games to users using computer systems and voice-over IP (VOIP) telephones and other devices. The e-learning system includes an authoring system allowing the creation of customized learning content and interactive learning games. A content presentation module presents learning content to users of computers and VOIP telephones and other devices. A data collection module receives user data from the VOIP device indicating the user's performance with the interactive game module. In a further embodiment, the e-learning system includes a user data presentation module to analyze the user data and to present reports including user data.

In an embodiment, the interactive learning games are designed to reinforce users' understanding of the instructional content provided by the content presentation module. In another embodiment, the interactive learning games are adapted to measure the users' understanding of the learning content provided by the content presentation module. In some applications, the learning content pertains to a function of the VOIP device and the interactive learning games simulate the functions of the VOIP device.

In an embodiment, the content presentation module and the interactive learning games communicate with VOIP devices via a middleware application server. The middleware application server converts the instructional content and the game to a format compatible with the VOIP device. In another embodiment, the e-learning system convert the learning content and the interactive games to a format compatible with VOIP devices.

In an embodiment, the content presentation module includes logic presents alternate instructional content to users via user computer systems. Similarly, the e-learning system presents at least one alternate game to users pertaining to the alternate instructional content via user computer systems.

### BRIEF DESCRIPTION OF THE DRAWINGS

The invention will be described with reference to the drawings, in which:

FIG. 1 illustrates an example portal page for an e-learning system according to an embodiment of the invention;

FIG. 2 illustrates an example interactive book for an e-learning system according to an embodiment of the invention;

FIG. 3A-3K illustrate example interactive learning games for an e-learning system according embodiment of the invention;

FIG. 4A-4E illustrate example interactive open learning games for an e-learning system according to an embodiment of the invention;

FIG. 5 illustrates an example library of interactive books and learning games for an e-learning system according to an embodiment of the invention;

FIG. 6A-6B illustrate an example reporting system of an e-learning system according to an embodiment of the invention;

FIGS. 7A-7B illustrate an example online store of e-learning applications for an e-learning system according to an embodiment of the invention;

FIG. 8 illustrates an e-learning application authoring system according to an embodiment of the invention;

FIG. 9 illustrates an example computer system suitable for implementing an e-learning system according to an embodiment of the invention;

FIG. 10 illustrates an example VOIP telephone suitable for presenting e-learning applications to users according to an embodiment of the invention;

FIG. 11 illustrates an example system architecture suitable for deploying and presenting e-learning applications to users via VOIP telephone networks according to an embodiment of the invention;

FIG. 12 illustrates an example data flow for deploying and presenting e-learning applications to users via VOIP telephone networks according to an embodiment of the invention;

FIG. 13 illustrates an example system architecture suitable for deploying and presenting e-learning applications to users via VOIP telephone networks according to an embodiment of the invention; and

FIG. 14 illustrates an example data flow for deploying and presenting e-learning applications to users via VOIP telephone networks according to an embodiment of the invention.

### DETAILED DESCRIPTION OF THE INVENTION

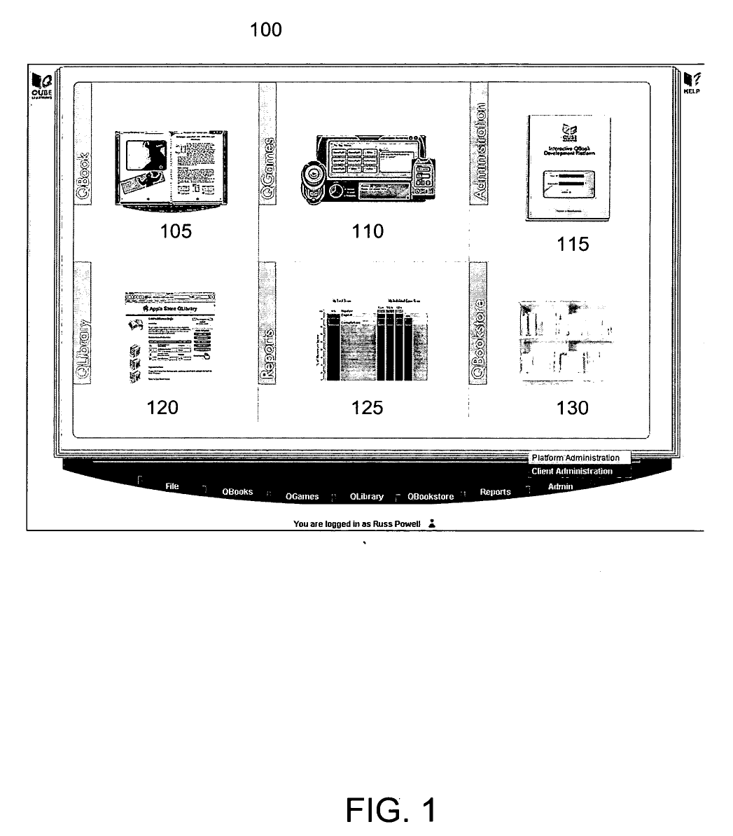

FIG. 1 illustrates an example portal page 100 for an e-learning system according to an embodiment of the invention. Portal page 100 enables users to navigate between the different modules of the e-learning system. These modules include interactive book modules 105, referred to as QBooks, interactive game modules 110, referred to as QGames, an Administration module 115, a library module for accessing sets of related interactive books and games 120, referred to as a QLibrary, a Reports module 125, and an online store module 130 enabling users to purchase additional interactive books and games, referred to as a QBookstore.

Interactive book modules 105 are easily customizable e-learning applications that incorporate a variety of text, graphics, video, and links to other applications, web-based documents, and/or electronic or paper documents in any form. Interactive book modules can include data in any standard or proprietary formats for representing text, hypertext, bit-mapped or vector graphics and animation, video, and sound.

Interactive game modules 110 implement a “Learn by Play” instructional design methodology. Interactive game modules 110 can be easily customized with content on any topic to provide organizations with educationally effective and engaging interactive games specifically tailored to the needs of organizations and its members.

The library modules 120 include a Learning Management System (LMS) that integrates interactive book modules, interactive game modules, and other reference resources. The library modules 120 enable collections of interactive book and game modules can be branded according to the needs of an organization, thereby providing a consistent brand identity for the organization. Library modules 120 also provide analytical functions, such as manager reports summarizing game results (and therefore skills mastery) by individual, region, job role, business unit.

Administration module 115 includes an authoring platform enabling organizations to develop and deploy customized interactive book modules 105, interactive game modules, and library modules 120. The administration module 115 also enables organizations to administrate the configuration of the e-learning system, its modules, and users.

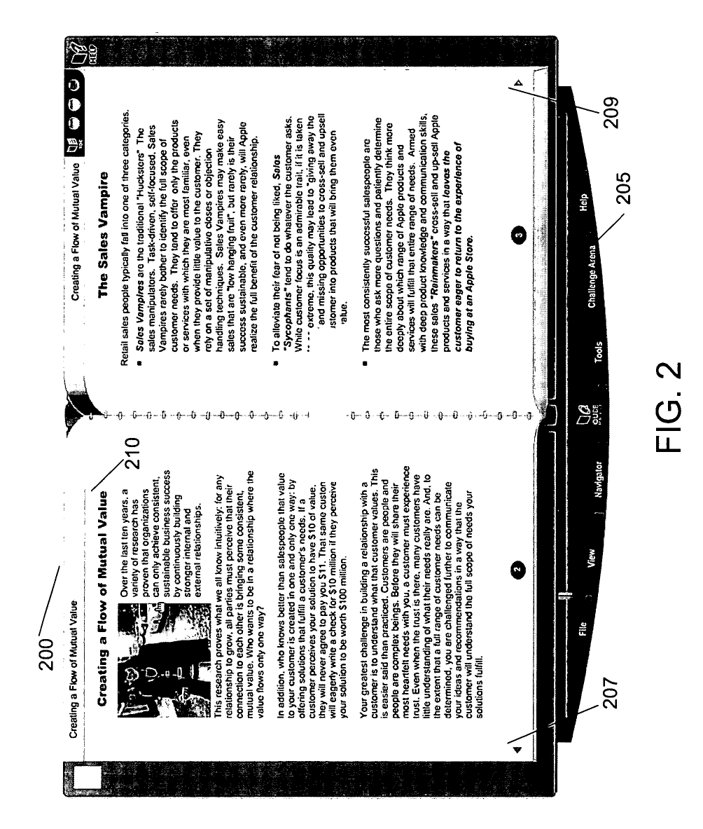

FIG. 2 illustrates an example interactive book module 200 for an e-learning system according to an embodiment of the invention. In an embodiment, interactive book module 200 combines the look-and-feel of an actual page-turning book with the functionality of a web page. Users can access interactive book module 200 electronically, for example using a web browser to access a web server hosting the interactive book module 200. In an additional embodiment, users can download a standalone version of the interactive book module 200 on to a personal computer. Once downloaded, the standalone version of the interactive book module 200 can be accessed by a user without the need for a network connection.

In an embodiment, the interactive book module presents content 210 in a two-page format similar to that of an open book. Users can access additional content by selecting controls 209 or 207 for the next or previous pair of pages, respectively. In a further embodiment, accessing an adjacent pair of pages is accompanied by a page turning animation.

Users can control the interactive book module 200 using a graphical user interface that includes a retractable dashboard 205. Dashboard 205 enables users to select functions including navigating between pages; viewing other hyperlinked content; adding notes, annotations, or bookmarks to the content 210; accessing a dictionary, glossary, or other reference materials; printing all or a portion of the content 210; downloading a standalone version of the interactive book module; and accessing one or more related interactive game modules.

To further enhance the book metaphor presented by the interactive book module 200, a further embodiment adds a graphic 215 at the edge of the page representing additional remaining pages. Graphic 215 changes size in proportion to the amount of content remaining following the current pair of pages. This provides users with a visual indication of the amount of content remaining in the interactive book module 200 in the form of the book's “thickness.”

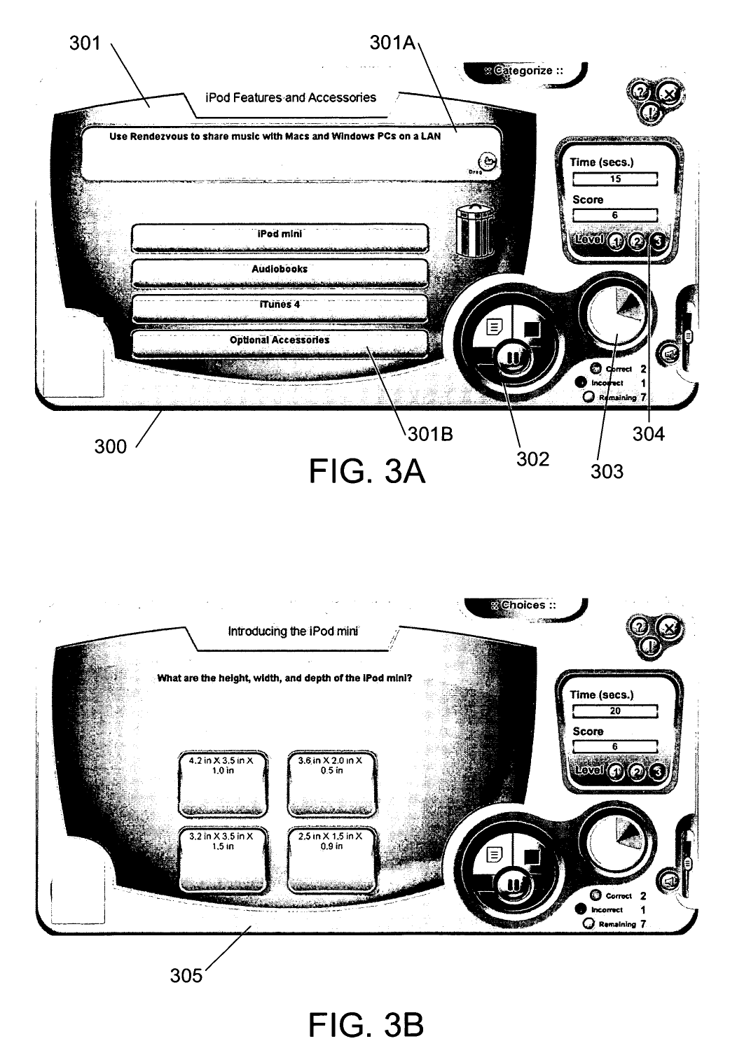

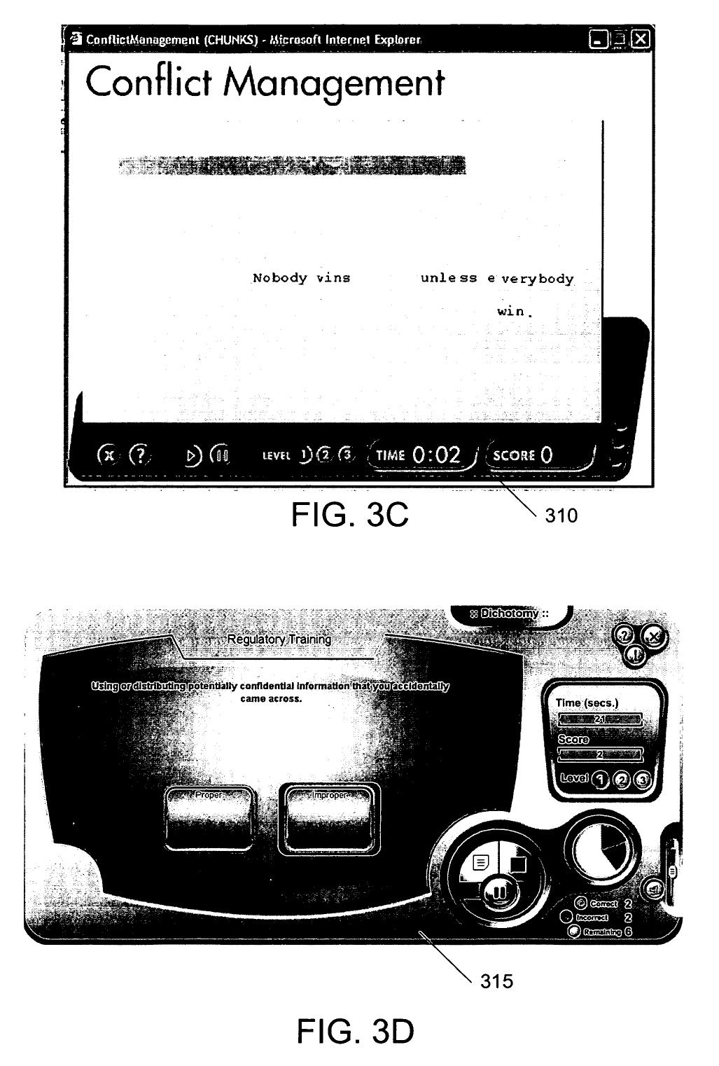

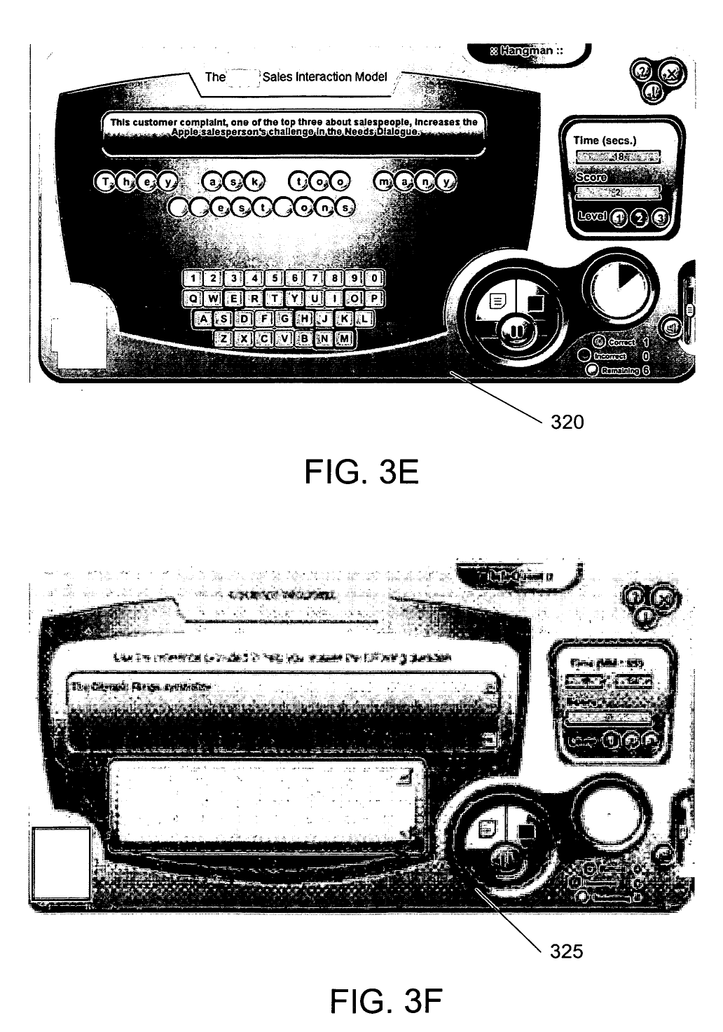

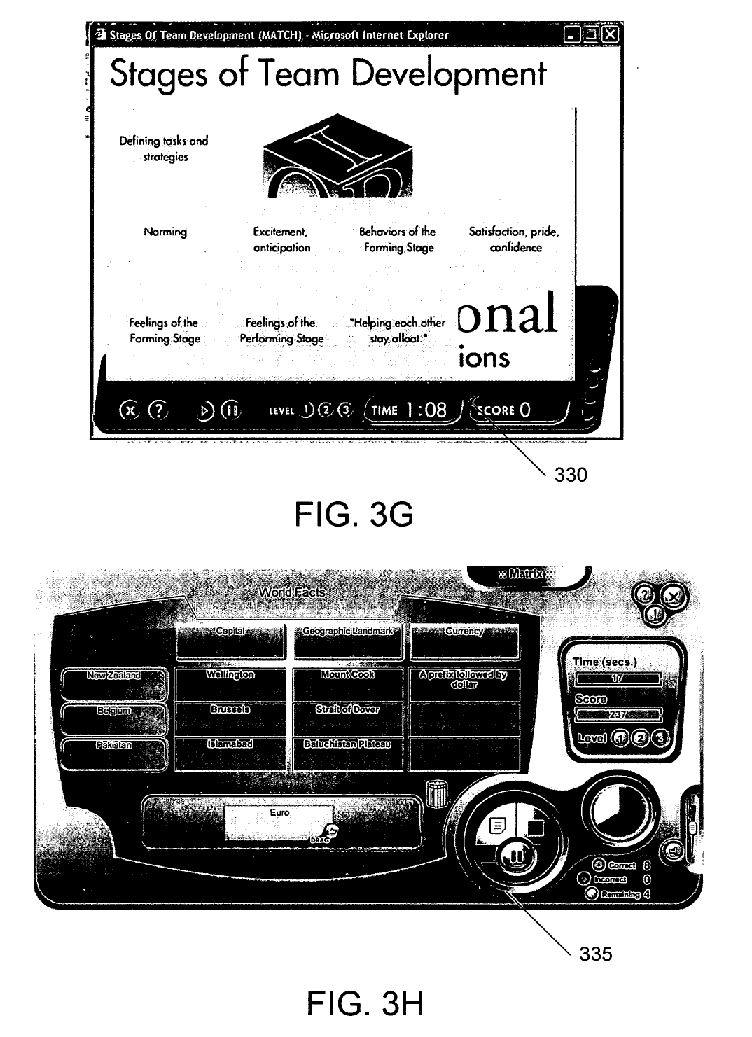

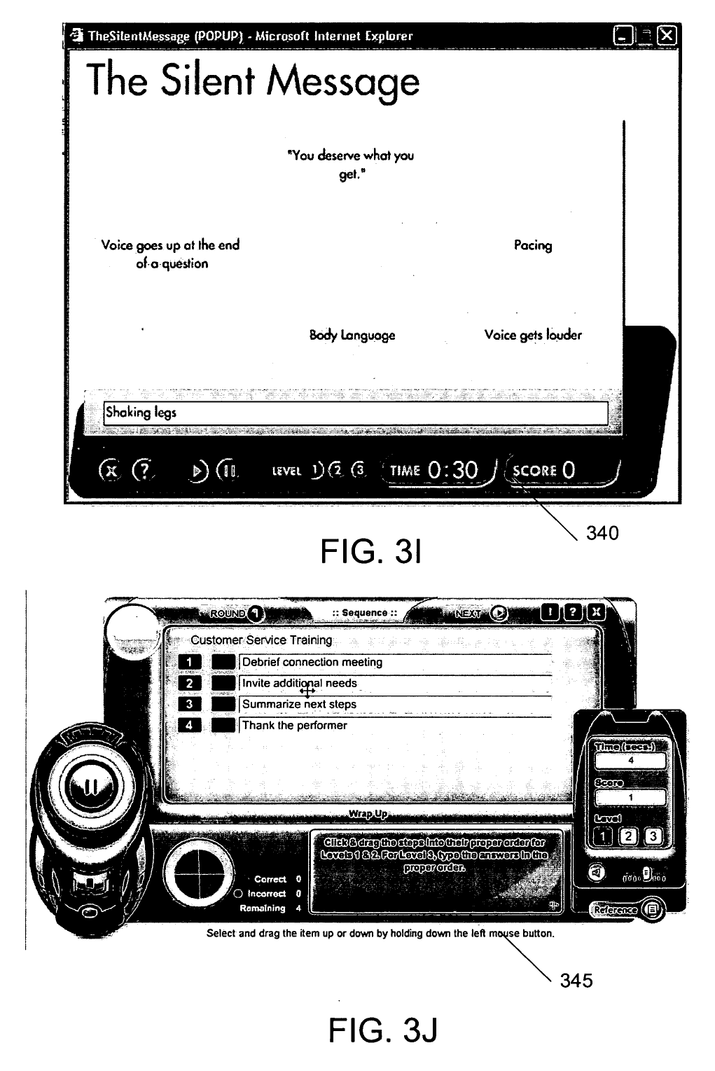

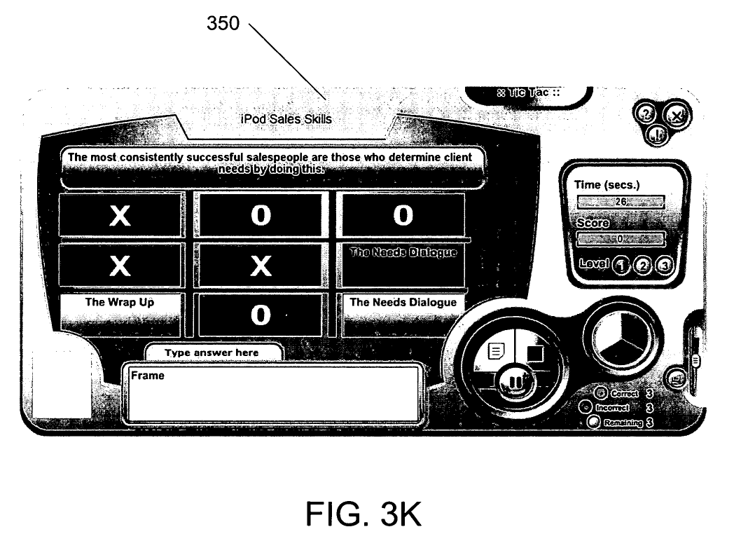

FIG. 3A-3K illustrate example interactive learning games for an e-learning system according embodiment of the invention. In an embodiment, an interactive games module can include one or more interactive learning games, such as the example interactive learning games discussed below. FIG. 3A illustrates an example 300 of a “Categorize” game. Example game 300 includes a content area 301 for displaying game content. In the example game 300, the content area 301 asks displays a question or statement 301a and asks the user to select one or more matching elements of a set of possible categories 301b.

A set of game controls 302 enable the user to stop the game, pause the game (if the game is timed), or to view reference materials to help the user make a correct selection. In an embodiment, the ability to let users view reference materials during a game (essentially, to “cheating”) can increase users retention of materials. In a further embodiment, this feature can be selectively enabled or disabled depending upon whether the purpose of the game is to help users learn and retain information or to assess their mastery of the game materials. In an embodiment, game 300 is accessed via a web browser connected with a web server hosting interactive game modules. In an additional embodiment, game controls 302 include a function enabling users to download a standalone version of the interactive game module 300 on to a personal computer. Once downloaded, the standalone version of the interactive game module 300 can be accessed by a user without the need for a network connection. Upon reconnecting with a network, interactive game module can automatically upload users' game scores to the e-learning system.

Example game 300 also includes game status displays 303 and 305 for indicating a user's progress in the game, a game difficulty level, a game score, and/or a game time. Game status display 304 also graphically indicates which questions the user has answered correctly or incorrectly. The interactive game module can automatically upload users' game scores to the e-learning system for storage and analysis. Users scores can be aggregated into a hall of fame or ranking system, providing users with encouragement to repeat games to improve their scores, and consequently enhance their learning.

FIG. 3B illustrates an example 305 of a “Choices” game. Like the example game 300, example game 305 includes a content area, game controls, and game status displays. In the “Choices” game, the user is presented with a question or statement and must select a correct response from a set of possible answers.

FIG. 3C illustrates an example 310 of a “Chunks” game. Like the example game 300, example game 310 includes a content area, game controls, and game status displays. In the “Chunks” game, the user is presented with a scrambled set of fragments of a target sentence or phrase, and the user must arrange these fragments in the proper sequence to form the target sentence or phrase.

FIG. 3D illustrates an example 315 of a “Dichotomy” game. Like the example game 300, example game 315 includes a content area, game controls, and game status displays. In the “Dichotomy” game, the user is presented with a question or statement and must select a correct response from a set of possible opposite answers.

FIG. 3E illustrates an example 320 of a “Hangman” game. Like the example game 300, example game 320 includes a content area, game controls, and game status displays. In the “Hangman” game, the user must form a target statement by making guessing the letters of the target statement, similar to the traditional “hangman”-style game.

FIG. 3F illustrates an example 325 of an “Infoquest” game. Like the example game 300, example game 325 includes a content area, game controls, and game status displays. In the “Infoquest” game, the user is presented with a question or statement and must enter an answer from the reference materials, such as an interactive book module, or other paper or electronic document, matching the statement or question.

FIG. 3G illustrates an example 330 of a “Match” game. Like the example game 300, example game 330 includes a content area, game controls, and game status displays. In the “Match” game, the user is presented with a set of covered tiles and must uncover matching pairs of tiles.

FIG. 3H illustrates an example 335 of a “Matrix” game. Like the example game 300, example game 335 includes a content area, game controls, and game status displays. In example 335 of the “Matrix” game, the user is presented with three categories and three items arranged in a grid. The user must provide a matching statement or answer for each combination of an item and category.

FIG. 31 illustrates an example 340 of a “Popup” game. Like the example game 300, example game 340 includes a content area, game controls, and game status displays. In the “Popup” game, the user is presented with a clue, question, or other prompt, and in response the user inputs an appropriate answer. This can be repeated for additional clues, answers, or prompts.

FIG. 3J illustrates an example 345 of a “Sequence” game. Like the example game 300, example game 345 includes a content area, game controls, and game status displays. In the “Sequence” game, the user is presented with a set of statements that must be sequenced correctly.

FIG. 3K illustrates an example 350 of a “Tic Tac Toe” game. Like the example game 300, example game 350 includes a content area, game controls, and game status displays. In the “Tic Tac Toe” game, each square of a tic tac toe board is associated with at least one statement or question, which the user must respond to appropriately to fill in the square.

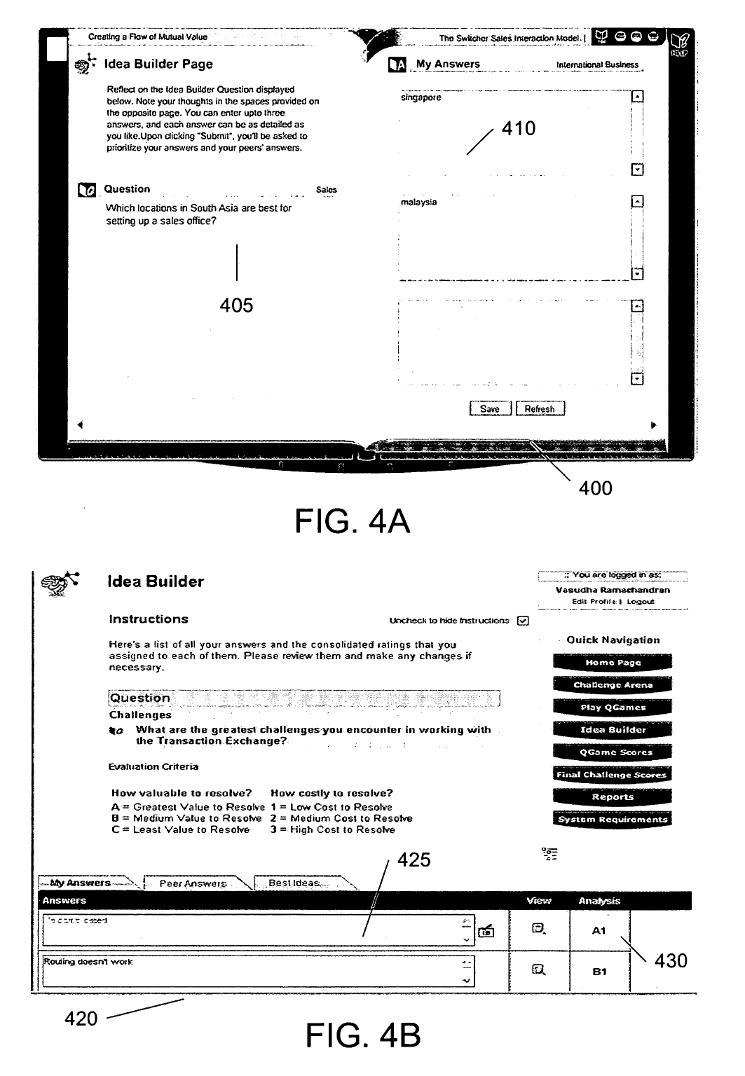

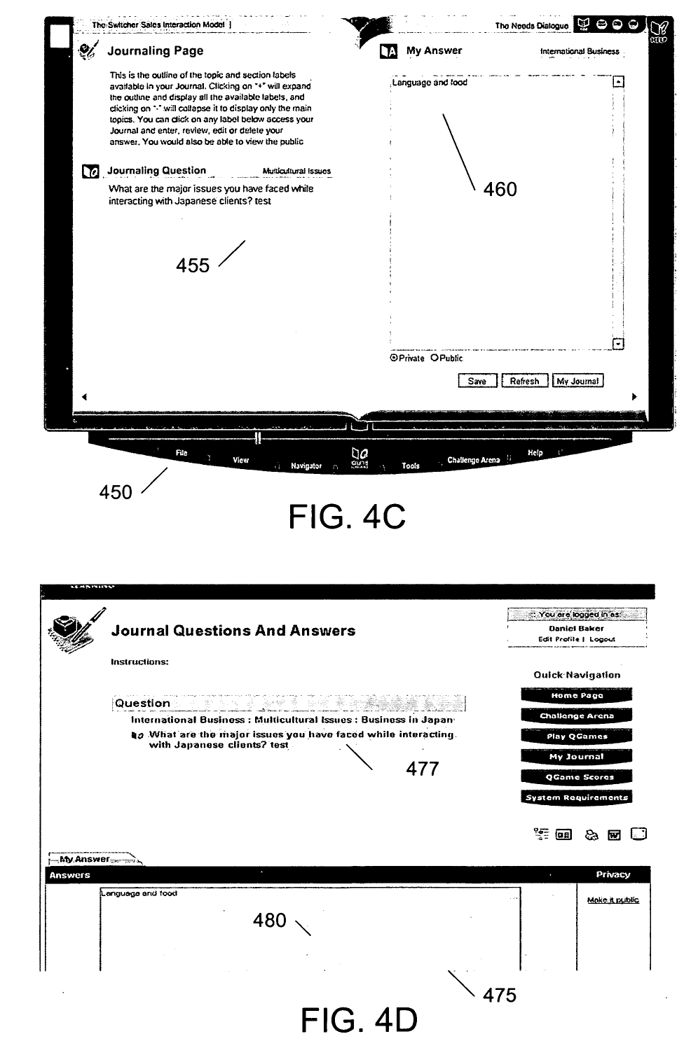

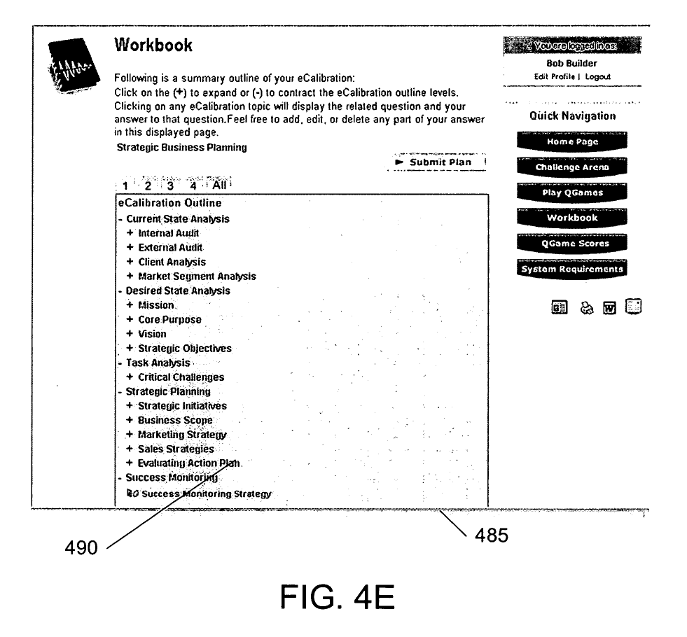

FIG. 4A-4E illustrate example interactive open learning games for an e-learning system according to an embodiment of the invention. Open games are games in which the user does not have to provide a predetermined answer; rather, the purpose of open games are to elicit new ideas from users and develop new skills.

FIG. 4A illustrates a first screen 400 of an example “Idea Builder” open game. The purpose of the “Idea Builder” game is to assist organizations and its members in brainstorming. Example screen 400 includes a content area 405 displaying one or more open-ended questions. In response to the contents of content area 405, a user supplies one or more answers in area 410. These answers are recorded by the interactive games module.

FIG. 4B illustrates a second screen 420 of an example “Idea Builder” open game. Example screen 420 displays answers 425 previously provided by the user, other random-selected users, and/or the current top-ranked users. In an embodiment, users rank each of their answers and those of one or more randomly selected peers according to one or more criteria. For example, an answer can be assigned a first rank based upon its anticipated benefit to the organization and a second rank based upon its anticipated cost. Users assign one or more rank values to each answer presented on screen 420 using input fields 430. The rank values of each answer are aggregated by the interactive games module to produce one or more cumulative rank values for each answer.

FIG. 4C illustrates a first screen 450 of an example “Journaling” open game. The purpose of the “Journaling” open game is to collect users' opinions on a variety of topics and to share these opinions with other users in the organization. Example screen 450 includes a content area 455 displaying one or more open-ended questions. In response to the contents of content area 450, a user supplies one or more answers in area 460. These answers are recorded by the interactive games module. FIG. 4D illustrates a second screen 475 of an example “Journaling” open game. Example screen 475 displays a user's previously provided answers 480 in response to displayed question 477. Users have the option of reviewing their answers to one or more questions and to make these answers public.

FIG. 4E illustrates an example screen 485 of a “Calibration” open game. The purpose of the “Calibration” game is to ensure that users in an organization provide similar responses when handling similar tasks. For example, a “Calibration” open game can be used to ensure that users in an organization grade exams or prepare reports in a consistent manner. Example screen 485 displays a list 490 of calibration tasks. For each calibration task, a user can provide his or her own response. Furthermore, users can view model answers for the calibration tasks and provide themselves with score based on how closely their answers match the model answers.

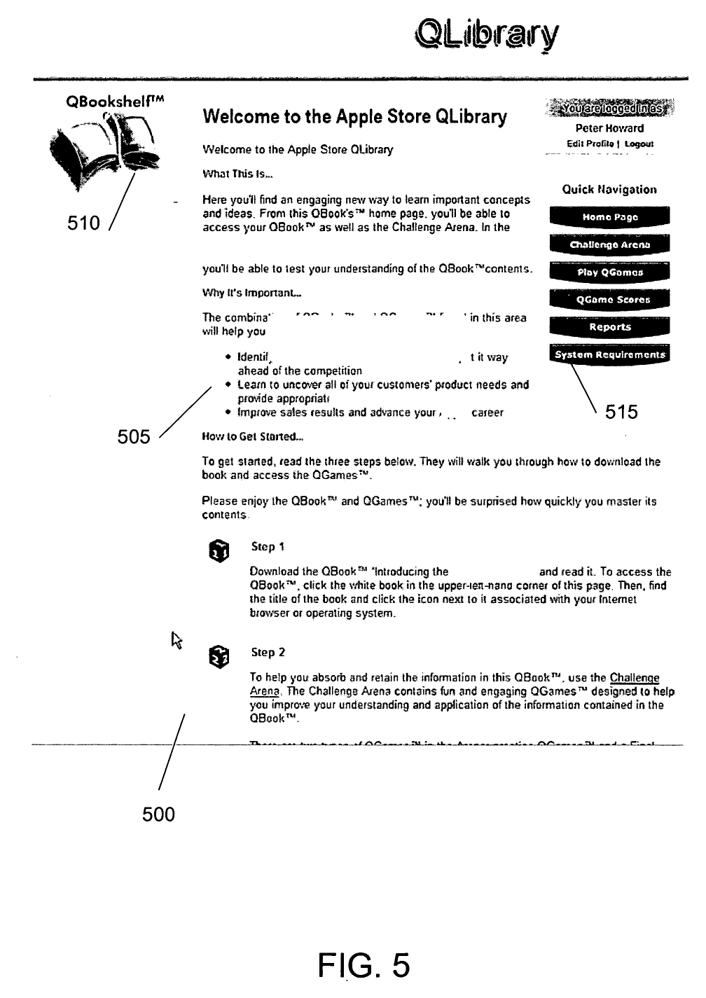

FIG. 5 illustrates an example library 500 of interactive book and learning game modules for an e-learning system according to an embodiment of the invention. Library 500 enables users to select related interactive book and game modules. In example library 500, instructions are displayed in area 505. Selecting “QBookshelf” 505 enables users to view a list of available sets of interactive book and game modules. After selecting a set of interactive book and game modules, users can access interactive book modules and related game modules as discussed above. In addition, a navigation bar 515 enables users to access portions of the e-learning system directly. In an embodiment, navigation bar 515 enables users to access interactive game modules tailored for learning and assessment, a record of their scores, and a report generator.

Under the scores section, example library 500 includes a Hall of Fame, which displays a summary of the best scores for all interactive game module performers; a Hall of Champions, which displays a list of the top interactive game module performers overall and for each game; a recommended reading section, which analyzes users' performances in response to questions and provides them with an individualized recommendation of specific pages in related interactive book modules, URLs, or other reference documents that they should review; a Certificates of Achievement section, which provides users with certificates, virtual trophies, or other rewards for achieving specific goals within the set of interactive game modules.

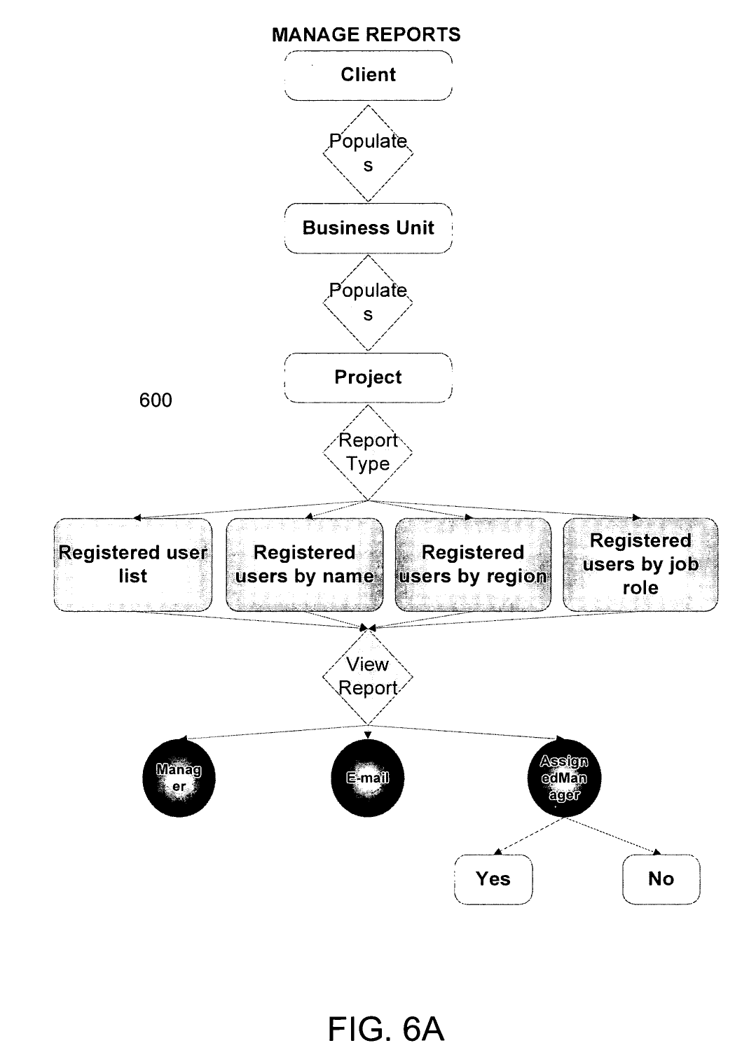

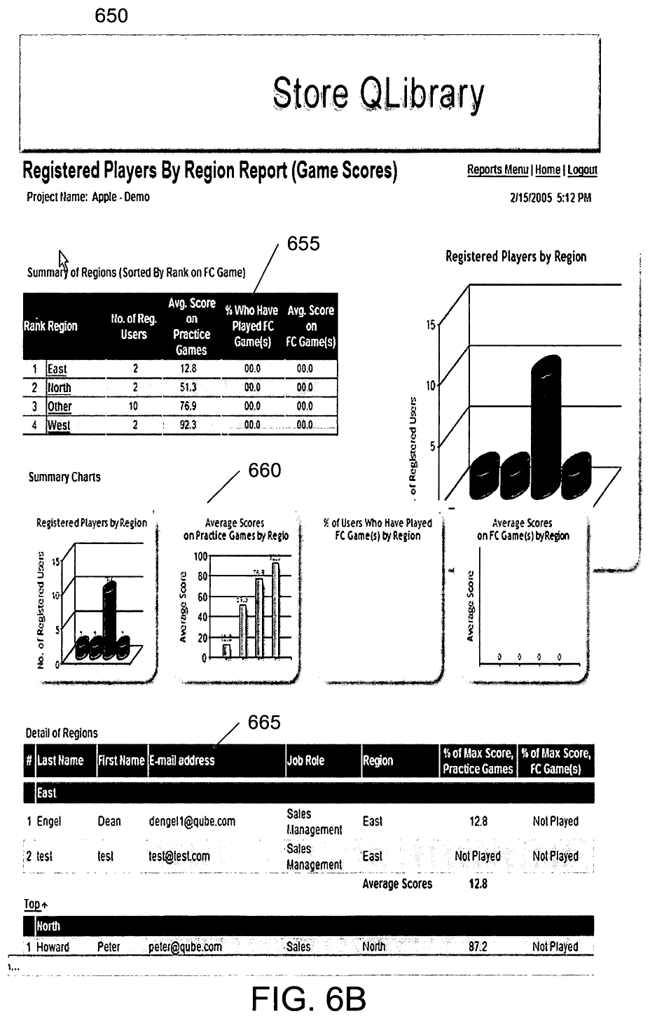

The report generator enables management to evaluate the success of the training initiatives for individuals, teams, regions, job roles, business units, to evaluate training at different levels of mastery, and to gather and display information on user best practices. FIG. 6A illustrates an example flowchart for a method 600 of a report generator module. In an embodiment of method 600, user data, which includes each user's game scores, name, job role, and region, is organized in a database according to organization or client, business unit, and project. Method 600 enables managers to generate reports according any of these criteria. Method 600 can then display or e-mail reports

In an embodiment, the report generator is operated using a graphical user interface to select the type of report to be created and the users to be included in the report. In a further embodiment, users can be selected individually, by organization, region, job role, and/or by score or ranking in one or more interactive game modules or any portion thereof. FIG. 6B illustrates an example report 650 created by the report generator according to an embodiment of the invention. Example report 650 presents the number of registered users according to regions. Example report 650 presents information in tables, such as table 655, and graphs, such as graph 660. In an embodiment, detailed information about a category, such as a region, is displayed in a second table 665.

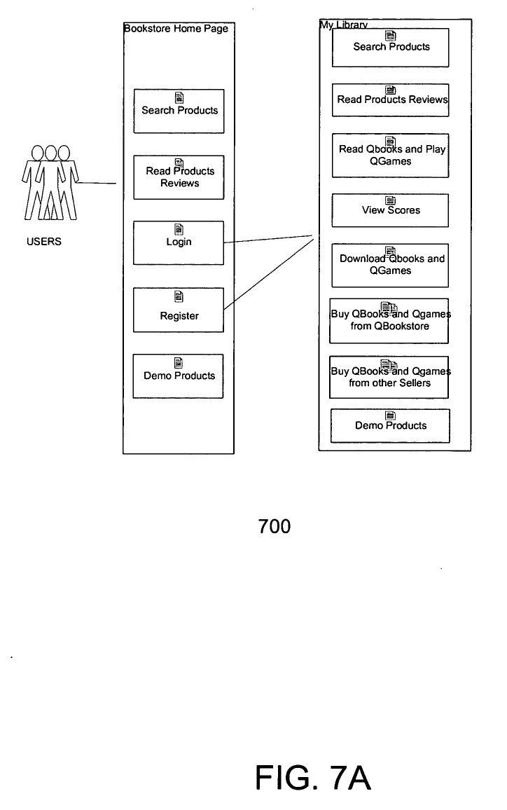

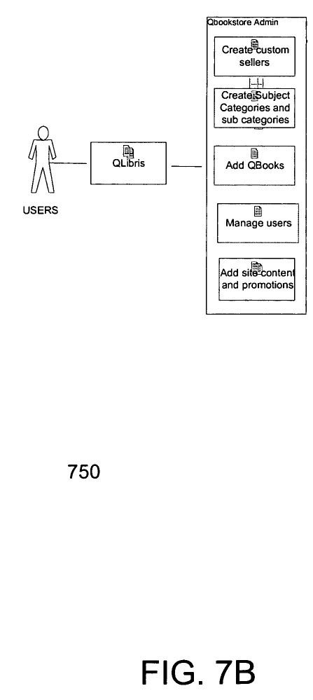

FIGS. 7A-7B illustrate an example online store of e-learning applications for an e-learning system according to an embodiment of the invention. In an embodiment, the online store provides a secure automated web interface for buying, searching, and viewing interactive book and game modules and other e-learning products. FIG. 7A illustrates user functions of an example online store 700 of e-learning applications according to an embodiment of the invention.

The functions of store 700 include a user registration, which allows users to register at the interactive book module store. An embodiment of store 700 provides two modes of registration: Register New User and Register Corporate User. Register New User allows individual users to purchase interactive book and game modules at online store 700. A visitor who visits the store 700 registers by providing his or her name, mailing address, phone number and email address. The store 700 allows the user to create a Login Id and Password that can be used to re-enter the site at anytime. Register Corporate User enables users associated with an organization to purchase interactive book and game modules for his or herself and other members of the organization. Registration for a corporate user requires that the user feed in her Login Id and Password of a corporate account. The system invokes a Web service at QLibrary behind the scenes that authenticates the user.

An embodiment of store 700 allows users that have already registered to log into the store 700 by providing the Login Id and Password created during registration. The login facility authenticates the user for valid login credentials and on successful authentication will grant access to features based on user role(s) defined in the system. User log in and log out activity can be maintained.

An embodiment of store 700 allows users to browse for available interactive book modules. The system presents the user with options to filter the search, such as Subjects, Authors, Sellers and Publication dates. The user can also narrow down the search further by entering a keyword. The store 700 also maintains a history of frequently searched subject by a user and can provide recommended interactive book and game module selections for the day on the same or similar subjects. In an embodiment, each selection will display information such as a cover picture, a title, an author, a brief description, reviews, and/or price. A virtual shopping cart feature enables users to purchase selections.

An embodiment of store 700 also includes a “Reading Room” feature that displays all the Interactive book modules and Interactive game modules purchased by the user, stacked on a bookcase. The books and games are organized on each shelf based on the subject. Users with corporate account will also see their corporate books if their corporation allows this facility. Each shelf has a game cabinet that contains games related to the books on the shelf. The reading room has a library assistant who provides online help to the user and answers his queries. The user can read books and play games online in the reading room or can download the Interactive book modules and Interactive game modules to his desktop to read and play offline.

An embodiment of store 700 also has a “View Scores” feature that enables users to view their personal score analyses and public halls of fame. The personal score analysis displays visual depiction of scores in the form of graphs and charts, list of recommended readings, history of games and certificates. The public halls of fame display scores of users in comparison with other individual users.

An embodiment of store 700 also includes an online demo section allowing users to view demos and excerpts of interactive book and game modules. A further embodiment of store 700 enables users to submit product reviews and to read reviews submitted by others.

FIG. 7B illustrates the features 750 of an example administrative interface for an online e-learning application store. These features 750 include an interface with an interactive book and game module authoring system, which allows creators of interactive book and game modules to add their creations to the online store. The set of features 750 also includes the ability to create customized, branded stores for specific organizations or clients. The set of features enables users to add or remove modules from the store, to receive and respond to customer queries by e-mail, and to notify customers via e-mail of their purchases and other modules available for purchase.

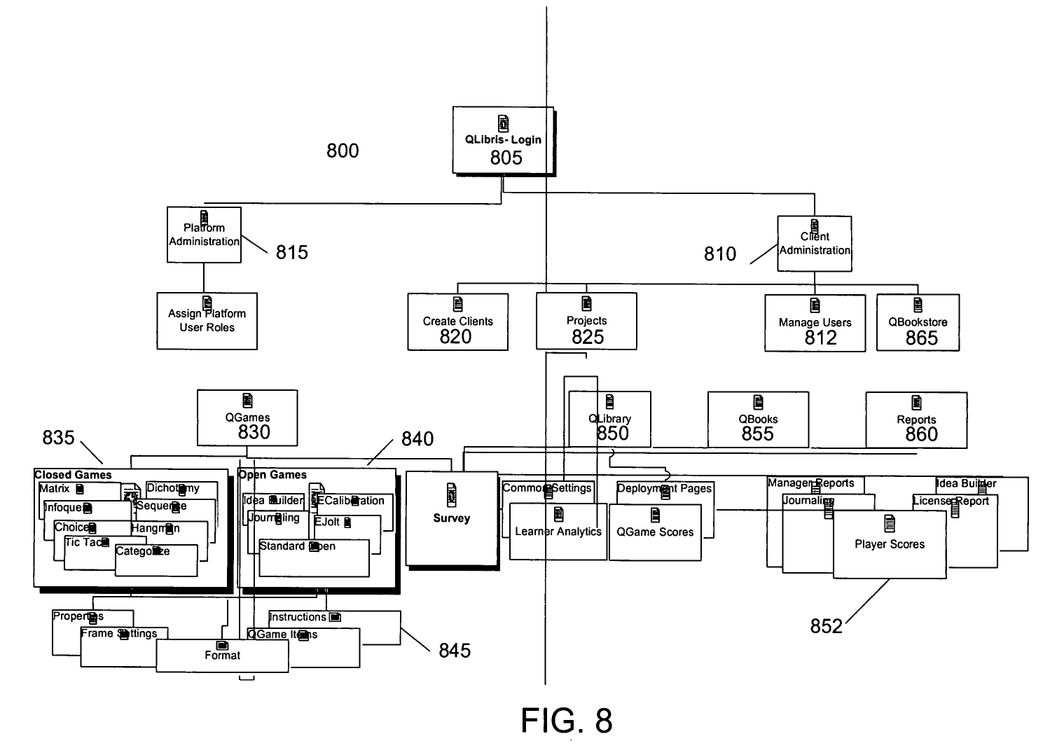

FIG. 8 illustrates an e-learning application authoring system 800 according to an embodiment of the invention. E-learning authoring system 800 enables users to create and deploy new interactive book and game modules, to manage users and organizations, and to generate reports. System 800 includes a login 805 enabling authorized users to access the system 800. The list of authorizes users is managed by platform administration module 815, which enables users to be added or removed from the system 800.

Client administration 810 enables users to create and manage different organizations or clients utilizing interactive book and game modules and includes a module 812 for managing users of interactive book and game modules, which can be different from the users of the authoring system 800; a module 820 for creating new clients or organizations; an online store module 865, as discussed above; and a project creation module 825 for creating and managing interactive book and game modules.

The project creation module 825 includes a game creation module 830 for creating closed games 835 and open games 840 as described above. In an embodiment, users of the system 800 can use one or more forms to enter the properties 845 of a game, such as the rules, questions and answers, specific references to interactive book modules or other resources, and scoring criteria. In another embodiment, a file including questions and answers in a tabular format, for example stored in a standard format spreadsheet file, can be uploaded to the game creation module 830 to rapidly enter or change a large number of questions.

A library module 850 enables users of the system 800 to link interactive book and game modules together, to set up and view analysis of book and game module users' performances, to deploy interactive book and game modules, and to track book and game module users' scores and rankings in a hall of fame, a hall of champions, and/or certificates of achievements. In an embodiment, this information, referred to as user data 852, is stored in a database.

An interactive book creation module 855 enables users of the system 800 to create and manage interactive book modules. In an embodiment, the system 800 provides a templates for one or more types of interactive book modules. Users can then insert their own content into a template to create a customized interactive book module. Templates can be provided in numerous different formats, such as HTML or Macromedia Flash.

A report generator module 860, similar to that discussed above, enables users to set up report templates and to generate reports of individual and aggregate interactive book and game module users' performances.

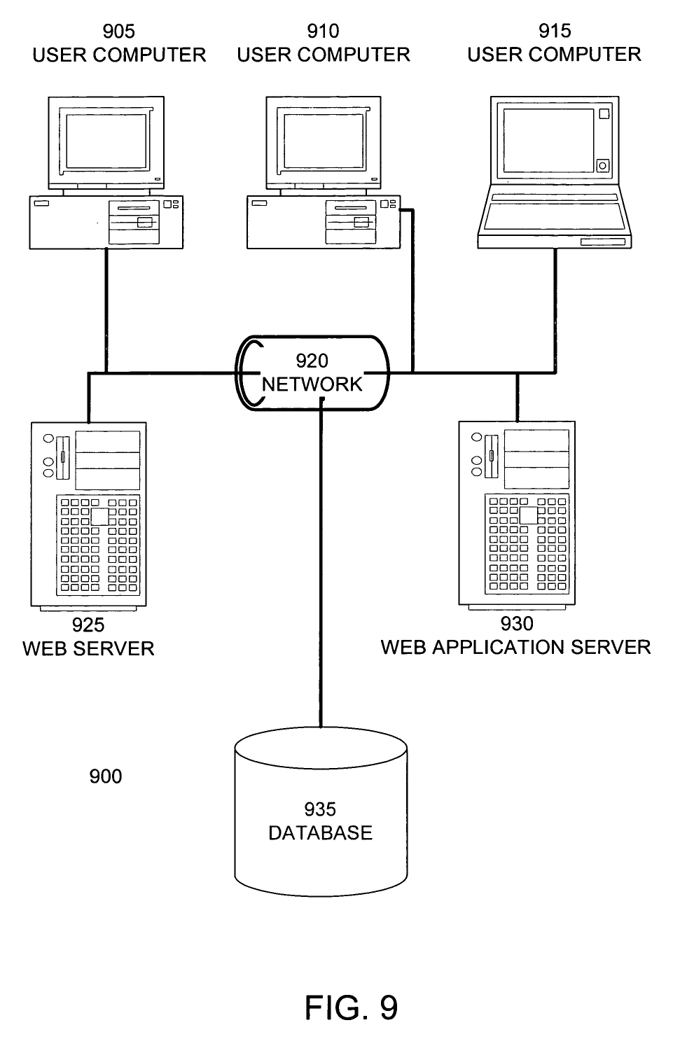

FIG. 9 is a block diagram of a system 900 for implementing an embodiment of the invention. System 900 includes user computers 905, 910, and 915. User computers 905, 910, and 915 can be general purpose personal computers having web browser applications. Alternatively, user computers 905, 910, and 915 can be any other electronic device, such as a thin-client computer, Internet-enabled mobile telephone, or personal digital assistant, capable of displaying and navigating web pages or other types of electronic documents. Although system 900 is shown with three user computers, any number of user computers can be supported.

A web server 925 is used to process requests for web pages or other electronic documents from user computers 905, 910, and 915. In an embodiment of the invention, all user interaction with the audit system is via web pages sent to user computers via the web server 925.

Web application server 930 operates the e-learning system. In an embodiment, the web application server 930 is one or more general purpose computers capable of executing programs or scripts in response to the user computers 905, 910 and 915. The web application can be implemented as one or more scripts or programs written in any programming language, such as Java, C#, Visual Basic, C, or C++, or any scripting language, such as Perl, Python, or TCL. The web application can be implemented in conjunction with platform technologies such as Microsoft's NET.

In an embodiment, the web application server 930 dynamically creates web pages for displaying the e-learning system and its data. The web pages created by the web application server 930 are forwarded to the user computers via web server 925. Similarly, web server 925 receives web page requests and input data from the user computers 905, 910 and 920, and forwards the web page requests and input data to web application server 930.

In an alternate embodiment, all or a portion of the e-learning system can be executed locally by each user computer. The locally executed portion of the e-learning system can be provided in a format native to the user computer or in a cross-platform format capable of running within a virtual machine or plug-in application on the user computer.

As the web application on web application server 930 processes data and user computer requests, data can be stored or retrieved from database 935. Database 935 stores general data used by every user of the e-learning system, such as interactive book and game modules. Database 935 also stores data associated with individual organizations and/or individual users of the e-learning system, such as scores and rankings.

An electronic communication network 920 enables communication between computers 905, 910, and 915, web server 925, web application server 930, and database 935. In an embodiment, network 120 may further include any form of electrical or optical communication devices, including wireless and wired networks. Network 930 may also incorporate one or more local-area networks, such as an Ethernet network; wide-area networks, such as the Internet; and virtual networks, such as a virtual private network.

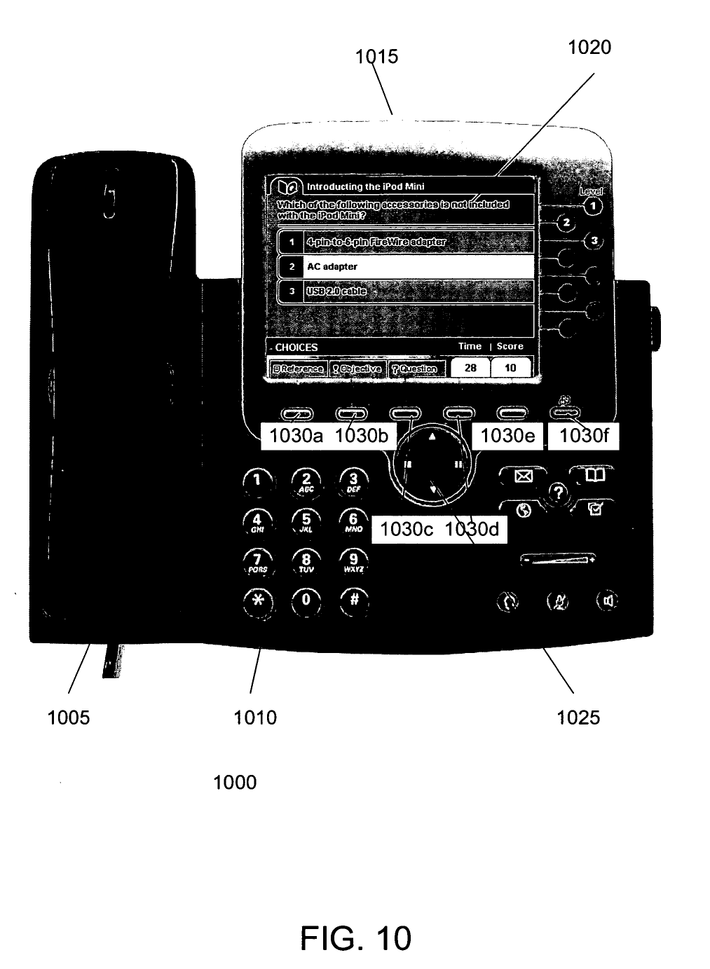

FIG. 10 illustrates an example VOIP telephone 1000 suitable for presenting e-learning applications to users according to an embodiment of the invention. VOIP telephone 1000 may include standard telephone features such as a receiver 1005 and a dialing keypad 1010. VOIP telephone 1000 can perform standard voice and/or video communications functions including initiating a call, receiving a call, switching between two or more calls, conference calling, voicemail functions, and/or storing frequently dialed numbers. Unlike a traditional telephone, VOIP telephone 1000 communicates voice, video, and other data over a general-purpose packet-switched network, instead of traditional dedicated, circuit-switched voice transmission lines. Voice, video, and other data may be routed over the packet-switched network directly to another VOIP phone, to another VOIP phone with the assistance of a VOIP server, and/or to a traditional telephone via a bridge or other connection between the packet-switched network and a circuit-switched network. VOIP telephone 1000 can apply data compression and decompression, error detection and correction, and network quality of service algorithms to maintain service quality.

In addition, VOIP telephone 1000 includes an interactive display unit 1015. Interactive display unit 1015 includes a video display screen 1020 adapted to display still images or animation. In embodiments, video display screen 1020 can display HTML, XML or XHTML formatted documents; bitmap and/or vector graphics; or any other type of static, animated, or hypertext display format. Interactive display unit 1015 also includes a direction pad 1025 and selection buttons 1030A-1030F adapted to navigate and operate a user interface presented on video display screen 1020.

Interactive display unit 1015 can display QBooks, QGames, the QLibrary, the QBookstore, and other elements of the e-learning system. In an embodiment, the e-learning system can include content, such as QBooks and QGames, in a number of different formats for compatibility with a variety of different computer systems as well as any number of different types of VOIP telephones. In a further embodiment, the e-learning system can transform content to two or more different formats for compatibility with different types of computer systems and/or VOIP telephones. This embodiment can employ standard data format conversion or presentation techniques, including XML transformations and stylesheet languages, such as CSS.

In a further embodiment, additional types of QBooks and QGames can be tailored specifically to VOIP telephones. One type of QBook tailored to VOIP telephones is a referred to as a QBit. A QBit is a brief multimedia presentation tailored to teach a specific task or concept. A typical QBit presentation last approximately two minutes. QBits can stand alone or be organized as part of a comprehensive learning modules.

QGames can be used to reinforce concepts presented in QBooks, and specifically QBits, presented on the VOIP telephone. QGames can reinforce concepts pertaining to a single QBook or QBit, or from multiple QBooks and/or QBits. In addition to the QGames discussed above, the e-learning system can include simulated task games. Simulated task games challenge users to perform a task, such as a task on their VOIP phone, to improve user's proficiency with the task. As with the other QGames, simulated task games can be integrated with the Hall of Fame, Hall of Champions, learning management system, and other aspects of the e-learning platform.

In one application, QBits and simulated task games can be used to build users' understanding and proficiency using VOIP telephones. For example, a VOIP telephone can present a QBit regarding a VOIP telephone function to a user, such how to initiate a conference call or use an electronic telephone directory, via the VOIP telephone. QGames conducted over the VOIP phone can then be used to build proficiency for this function. For example, a simulated task game can challenge user's to initiate mock conference calls. During this simulated task game, the user operates the appropriate controls of the VOIP telephone, with the control inputs of the VOIP phone being redirected to the QGames module, rather than actually operating the VOIP phone. Similarly, the displays presented on the interactive display unit 1015 are generated by the QGames module and adapted to emulate the look and feel of the normal operation of the VOIP phone.

In another application, QBits and QGames can be used to educate users in environments where traditional computers are not widely available. For example, retail store employees may not have assigned desks or workstations equipped with computers. However, most organizations have at least one telephone. By using the VOIP telephone as the delivery platform, organizations can utilize e-learning to educate their users without the need to invest in extraneous computers or other technology. Moreover, organizations can allow their users to participate in e-learning sessions on an informal schedule. For example, rather than scheduling a meeting or training session for a large number of users at once, an organization can schedule short individual training sessions for each user as convenient. In a further application, each user can initiate an individual training session on demand, as his or her own schedule permits.

In yet another application, QBits and optionally QGames can be frequently updated to meet the training and motivational needs of an organization. For example, an organization can present a different QBit to its users on a daily or weekly basis, or according to any other schedule or requirement. For example, an organization can present a different QBit to its users at the start of every day, or prior to an organizational event, such as a promotional sale or organizational event.

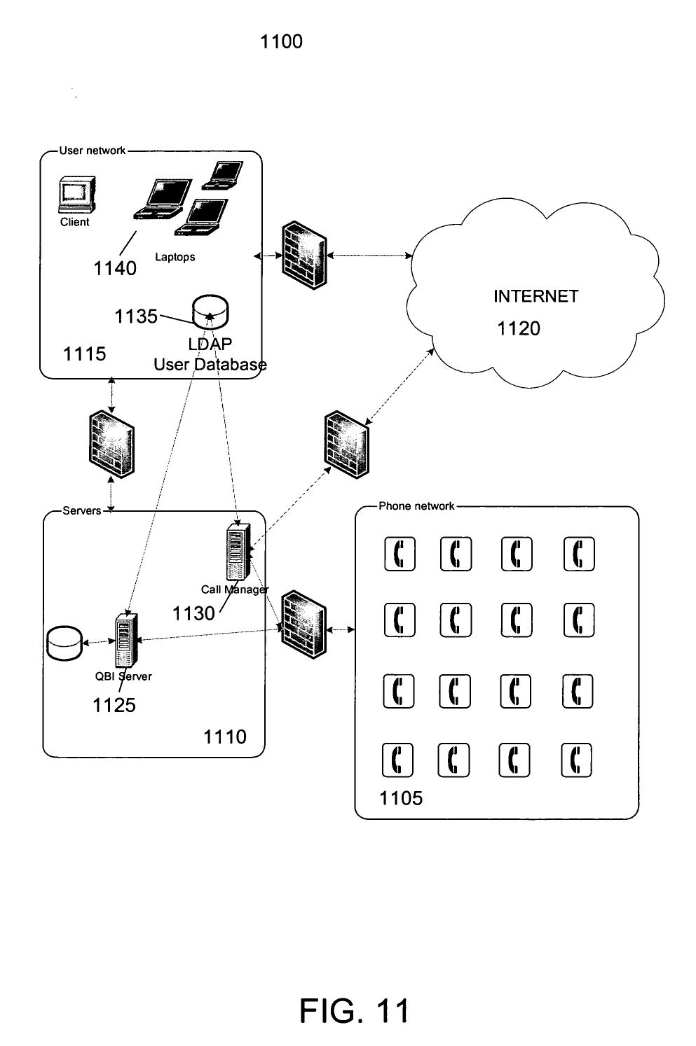

FIG. 11 illustrates an example system architecture 1100 suitable for deploying and presenting e-learning applications to users via VOIP telephone networks according to an embodiment of the invention. System architecture 1100 includes one or more VOIP telephones 1105, one or more servers 1110, optionally one or more user computers 1115, and an optional wide-area network 1120, such as the Internet.

The VOIP telephones 1105 can include standalone telephone systems, such as that described above, and/or wireless or mobile telephones, personal digital assistants, or other mobile or desktop computing devices capable of communicating audio, video, or other data over a packet-switched network using VOIP or other types of protocols.

The VOIP telephones 1105 are connected via a local and/or wide-area network with one or more servers 1110. Servers 1110 can include an e-learning system server 1125 adapted to implement the above-described e-learning system. Servers 1110 can optionally include a call manager server 1130 for coordinating VOIP traffic to and from VOIP telephones. For decentralized or peer-to-peer VOIP systems, the call manager server 1130 may be omitted. In an embodiments of system architecture 1100, the servers 1110 can be operated as software applications running on one or more server computers.

System architecture 1100 also may optionally include user computer infrastructure 1115. User computer infrastructure 1115 can include a database system 1135 and user computer systems 1140. Database system 1135 can be connected with the e-learning system server 1125 and call manager server 1130 to provide these servers with a directory of users. In an embodiment, user computer systems 1140 can include one or more computers for creating or modifying content for QBooks, QBits, QGames, and other portions of the e-learning system. User computer systems 1140 can include one or more computers for tracking users' progress with the e-learning system, for example through a LMS provided by the e-learning system. In an embodiment, system architecture 1100 allows user computer systems 1140 and VOIP telephones 1105 to be used in conjunction with the e-learning system described above. In this embodiment, user computer systems 1140 can include one or more computers for viewing QBooks, QBits, the QLibrary, and QBookstore as well as playing QGames.

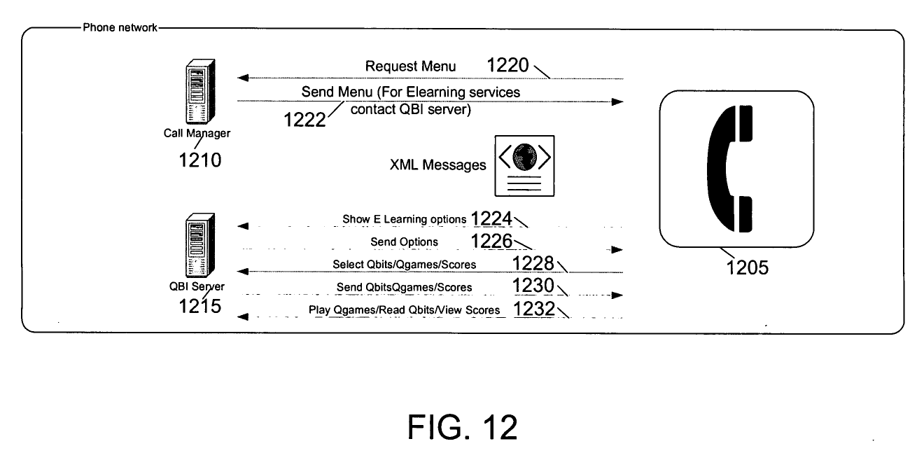

FIG. 12 illustrates an example data flow 1200 for deploying and presenting e-learning applications to users via VOIP telephone networks according to an embodiment of the invention. Data flow 1200 includes messages exchanged over a packet-switched local or wide-area network between a VOIP telephone 1205, a call manager server 1210, and an e-learning system server 1215. In an embodiment, the messages are encoded in an XML format.

In this embodiment, the VOIP telephone 1205 sends a menu request message 1220 to the call manager server 1210. In response to menu request message 1220, call manager server 1210 sends message 1222 including a menu of available options to the VOIP telephone 1205. One of the options in this menu is a link to the e-learning system hosted by the e-learning server 1215.

In response to the selection by a user of this menu link to the e-learning system, VOIP telephone 1205 sends message 1224 to the e-learning server 1215. Message 1224 requests a list of available e-learning system options. In response, the e-learning server 1215 returns message 1226, which can include links to available QBooks, QGames, QBits, the QLibrary, the QBookstore, hall of fame or score ranking lists, and other aspects of the e-learning system.

User selections of e-learning system options are communicated with the e-learning server 1215 via messages 1228 and the e-learning server 1215 provides the appropriate content to the VOIP telephone 1205 via messages 1230. Further interactive communications, such as for reading QBooks or QBits and/or playing QGames, are carried by messages 1232 between the VOIP telephone 1205 and the e-learning server 1215.

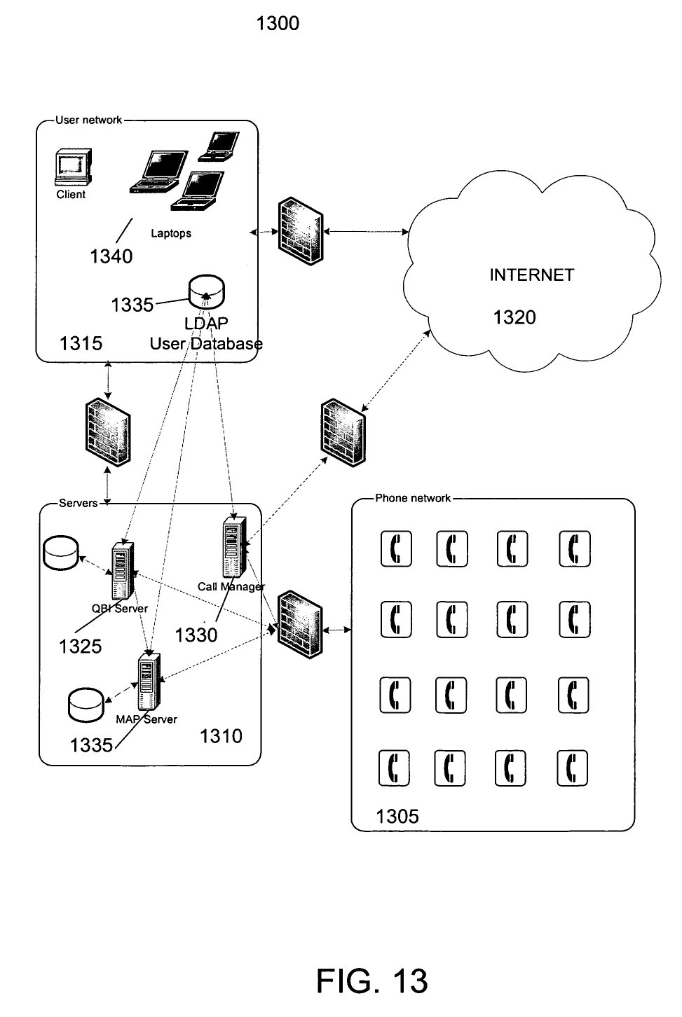

FIG. 13 illustrates an example system architecture 1300 suitable for deploying and presenting e-learning applications to users via VOIP telephone networks according to an embodiment of the invention. System architecture 1300 is similar to system architecture 1100 and includes one or more VOIP telephones 1305, one or more servers 1310, optionally one or more user computers 1315, and an optional wide-area network 1320, such as the Internet.

The VOIP telephones 1305 can include standalone telephone systems, such as that described above, and/or wireless or mobile telephones, personal digital assistants, or other mobile or desktop computing devices capable of communicating audio, video, or other data over a packet-switched network using VOIP or other types of protocols.

The VOIP telephones 1305 are connected via a local and/or wide-area network with one or more servers 1310. Servers 1310 can include an e-learning system server 1325 adapted to implement the above-described e-learning system. Servers 1310 can optionally include a call manager server 1330 for coordinating VOIP traffic to and from VOIP telephones. For decentralized or peer-to-peer VOIP systems, the call manager server 1330 maybe omitted. Unlike system architecture 1100, system architecture 1300 includes a middleware application server 1335. As discussed in detail below, middleware application server 1335 is adapted to convert content into formats suitable for display and user interaction on a wide variety of different types of VOIP telephones and other communication devices adapted to communicate over a packet switched communications network using wired or wireless means. In an embodiments of system architecture 1300, the servers 1310 can be operated as software applications running on one or more server computers.

System architecture 1300 also may optionally include user computer infrastructure 1315. User computer infrastructure 1315 can include a database system 1335 and user computer systems 1340. Database system 1335 can be connected with the e-learning system server 1325 and call manager server 1330 to provide these servers with a directory of users. In an embodiment, user computer systems 1340 can include one or more computers for creating or modifying content for QBooks, QBits, QGames, and other portions of the e-learning system. User computer systems 1340 can include one or more computers for tracking users' progress with the e-learning system, for example through a LMS provided by the e-learning system. In an embodiment, system architecture 1300 allows user computer systems 1340 and VOIP telephones 1305 to be used in conjunction with the e-learning system described above. In this embodiment, user computer systems 1340 can include one or more computers for viewing QBooks, QBits, the QLibrary, and QBookstore as well as playing QGames.

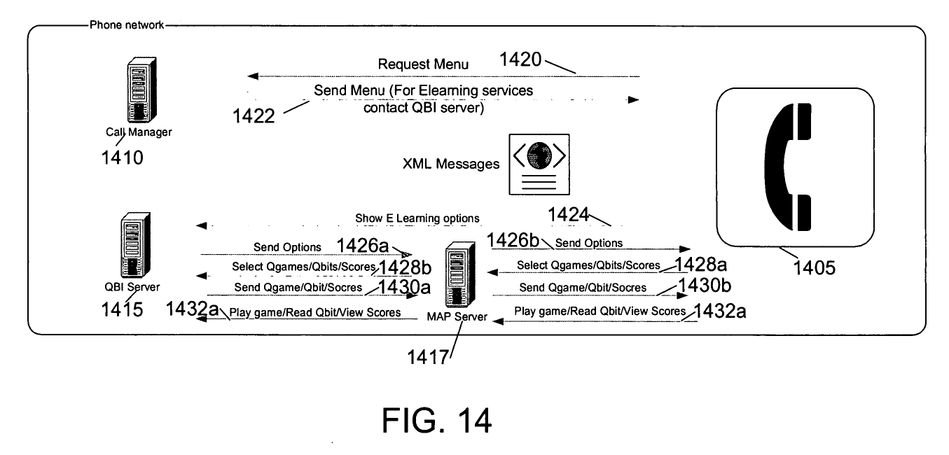

FIG. 14 illustrates an example data flow 1400 for deploying and presenting e-learning applications to users via VOIP telephone networks according to an embodiment of the invention. Data flow 1400 includes messages exchanged over a packet-switched local or wide-area network between a VOIP telephone 1405, a call manager server 1410, an e-learning system server 1415, and a middleware application server 1417. In an embodiment, the messages are encoded in an XML format.

In this embodiment, the VOIP telephone 1405 sends a menu request message 1420 to the call manager server 1410. In response to menu request message 1420, call manager server 1410 sends message 1422 including a menu of available options to the VOIP telephone 1405. One of the options in this menu is a link to the e-learning system hosted by the e-learning server 1415.

In response to the selection by a user of this menu link to the e-learning system, VOIP telephone 1405 sends message 1424 to the e-learning server 1415. Message 1424 requests a list of available e-learning system options. In response, the e-learning server 1415 returns message 1426a, which can include links to available QBooks, QGames, QBits, the QLibrary, the QBookstore, hall of fame or score ranking lists, and other aspects of the e-learning system. Message 1426a is communicated with the middleware application server 1417. Middleware application server 1417 converts messages between the e-learning server 1415 and the VOIP telephone 1405 into formats compatible with their respective destinations. Thus, the middleware application server 1417 converts message 1426a into message 1426b, which is compatible with the destination VOIP telephone 1405.

User selections of e-learning system options are communicated with the e-learning server 1415 via messages 1428a and 1428b and the e-learning server 1415 provides the appropriate content to the VOIP telephone 1405 via messages 1430a and 1430b. Further interactive communications, such as for reading QBooks or QBits and/or playing QGames, are carried by messages 1432a and 1432b between the VOIP telephone 1405 and the e-learning server 1415.

The e-learning system provides a foundation for implementing several novel learning methodologies. One methodology focuses on designing a learning curriculum. In an embodiment, a curriculum includes content, such as interactive book and game modules and/or other offline or online content, pertaining to core knowledge, skills, and attitudes that are applicable to any task or job. Examples of core knowledge, skills, and attitudes include problem solving, asking appropriate questions, resolving differences and objections, helping others, listening, creative thinking skills, accountability, optimism, achievement orientation, goal setting, and empathy. Once a learning curriculum introduces content for core knowledge, skills, and/or attitudes, the learning curriculum can introduce additional content pertaining to specific learning goals. This additional content can include information on applying core knowledge, skills, and attitudes to specific learning goals.

An additional learning methodology maximizes an organization's investment in training across many different learning programs. In an embodiment, instructional materials are classified according to three different categories: mandatory content and time; mandatory time and voluntary content; and voluntary content and time. The first category is for information that users must learn and must spend a minimum amount of time or acquire a minimum level of proficiency. The second category is for content that can be selected by users (for example, from a list of approved topic) but in which users must devote a minimum amount of time or acquire a minimum level of achievement. The third category is for content that is completely voluntary in terms of both the topic selected and the minimum amount of time or achievement required.

Organizations can efficiently allocate their resources by offering as few as courses as possible in the first category. For these courses, additional interactivity, in the form of a large number of interactive book and game modules can be created to retain the interest of as many users as possible. For the second category of information, organizations can offer a broad range of elective topics. For these courses, the interactivity can be decreased (hence decreasing the costs), as users are more engaged by selecting topics of interest. For the third category, organizations can offer a reduced number of courses and limit the interactivity and cost, as users taking courses in these categories are highly motivated to learn.

Another learning methodology is a blended learning approach the uses the e-learning system in conjunction with other online or offline training, such as meetings, workshops, and practice sessions. In an embodiment, the e-learning system is used to “bookend” the other training, such that learning begins with the e-learning system, is followed by other training, and then ends with additional use of the e-learning system. This embodiment provides users with increased retention and enables organizations to assess the effectiveness of the training.

Although the invention has been discussed with respect to specific embodiments thereof, these embodiments are merely illustrative, and not restrictive, of the invention. For example, the present invention can be utilized with any authentication system. Thus, the scope of the invention is to be determined solely by the claims.

What is claimed is:

1. An e-learning system connected with a packet-switched communications network and adapted to communicate with at least one VOIP device, the e-learning system comprising:
a content presentation module including logic adapted to present instructional content to a user via the VOIP device;
an interactive game module including logic adapted to present at least one game to the user pertaining to the instructional content via the VOIP device; and
a data collection module including logic adapted to receive user data from the VOIP device indicating the user's performance with the interactive game module.

2. The e-learning system of claim 1, wherein the VOIP device is a VOIP telephone including a display screen.

3. The e-learning system of claim 1, wherein the game is adapted to reinforce the user's understanding of the instructional content provided by the content presentation module.

4. The e-learning system of claim 1, wherein the game is adapted to measure the user's understanding of the instructional content provided by the content presentation module.

5. The e-learning system of claim 1, wherein the instructional content pertains to a function of the VOIP device.

6. The e-learning system of claim 5, wherein the game simulates the function of the VOIP device.

7. The e-learning system of claim 1, wherein the e-learning system is connected with-a computer system via the packet-switched network, the e-learning system further comprising a user data presentation module including logic adapted to analyze the user data and to present a report including user data via the computer system.

8. The e-learning system of claim 1, wherein the content presentation module and the interactive game module include logic adapted to communicate with the VOIP device via a middleware application server, wherein the middleware application server includes logic adapted to convert the instructional content and the game to a format compatible with the VOIP device.

9. The e-learning system of claim 1, wherein the content presentation module and the interactive game module include logic adapted to convert the instructional content and the game to a format compatible with the VOIP device.

10. The e-learning system of claim 9, wherein the content presentation module and the interactive game module are adapted to use an XML transformation to convert the instructional content and the game to the format compatible with the VOIP device.

11. The e-learning system of claim 1, further comprising an interactive game creation module including logic adapted to receive a set of questions and a corresponding set of answers from a game designer and logic adapted to create the game, wherein the game includes the set of questions and the set of answers.

12. The e-learning system of claim 1, wherein the content presentation module includes logic adapted to present alternate instructional content to a user via a user computer system and the interactive game module connected includes logic adapted to present at least one alternate game to the user pertaining to the alternate instructional content via the user computer system.

13. The e-learning system of claim 12, wherein the alternate instructional content is an expanded version of the instructional content.

14. The e-learning system of claim 12, wherein the content presentation module includes logic adapted to present the alternate instructional content in a paginated book format.
